(19) United States
(12) Patent Application Publication
(10) Pub. No.: US 2023/0184064 A1
(43) Pub. Date: Jun. 15, 2023

(54) ADDITIVE MANUFACTURED MANIFOLDS WITH REMOVABLE CONNECTIONS

(71) Applicant: Baker Hughes Energy Technology UK Limited, Bristol (GB)

(72) Inventors: Michelangelo FABBRIZZI, Prato (IT); Pietro Castelli, Firenze (IT); Giovanni Biffaroni, Monteriggioni (IT)

(73) Assignee: Baker Hughes Energy Technology UK Limited, Bristol (GB)

(21) Appl. No.: 18/077,309

(22) Filed: Dec. 8, 2022

Related U.S. Application Data
(60) Provisional application No. 63/289,239, filed on Dec. 14, 2021.

(51) Int. Cl. E21B 43/017; B33Y 80/00

(52) U.S. Cl. CPC E21B 43/0175; B33Y 80/00

(57) ABSTRACT

A manifold for subsea recovery operations with reduced welding requirements through the use of additive manufacturing and prefabrication. The manifold can be combined with other manifolds and includes fewer leakage/failure points due to the reduced number of welds in the manifold.

### CROSS-REFERENCE TO RELATED APPLICATION

This application claims the benefit of U.S. Provisional Application No. 63/289,239, filed Dec. 14, 2021, entitled “ADDITIVE MANUFACTURED MANIFOLDS WITH REMOVABLE CONNECTIONS,” which is hereby incorporated in its entirety.

### BACKGROUND

### Field of the Invention

This invention relates in general to subsea distribution units and more particularly to connections and manifolds for these units.

### Description of the Prior Art

A typical subsea drilling operation includes a surface platform or vessel at the sea surface, which is connected to one or more underwater piping trees. The piping trees can consist of a series of valves controlling fluid flow at a wellhead. Manifolds can be capable of comingling produced fluids from multiple trees before the fluids are transported to the surface platform or vessel via a riser. In addition, Subsea Distribution Units (“SDUs”) can typically be used to distribute control signals, electrical power, hydraulic power, and chemicals to the rest of the subsea field. Some of these subsea structures (e.g., manifolds, SDUs, etc.) include piping networks and structures that can be quite complex. Traditionally, these systems are manufactured by welding individual pieces of piping, tubing, connectors, and fittings together.

Welded piping and connectors introduce a number of disadvantages into the manufacturing process of SDUs and subsea manifolds. Welding can increase the cost to manufacture the SDU as it requires specialized welders and inspections due to the subsea environment the structure will be placed in. The welding and inspection process can also increase the required lead time of the tubing network due to the specialized and complex welding that is required. Welds that fail the inspection process need to be remade which can further increase both the lead time and cost of manufacturing. Reducing the number of welds in an SDU through the use of new technologies can reduce both the lead time and cost of SDU manufacturing.

### SUMMARY

A first embodiment of the present technology provides for a subsea distribution system. The subsea distribution system can include a manifold made with a unitary material. The manifold can include a plurality of connection points for connecting elements and other manifolds.

In some embodiments, the element connection points can be clamp connections. The element connection points can also be multi-quick connections.

In some embodiments, there can be at least one additional manifold connected to the first manifold. The at least one additional manifold can be connected using bolts with threaded bars to the first manifold. The manifolds can be manufactured using additive manufacturing.

A second embodiment of the present technology provides for an offshore recovery system. The system can include a surface platform or floating production unit. The system can also include at least one umbilical or hydraulic flying lead connected to the surface platform or floating production unit. The system can also have a first manifold made with a unitary material connected to the at least one umbilical or hydraulic flying lead. Finally, the system can contain at least one piping tree connected to the first manifold.

In some embodiments, tubing systems made from unitary materials can connect the at least one umbilical or hydraulic flying lead to the manifold. The unitary tubing sections can be prefabricated or shaped into a prespecified configuration.

There can be additional manifolds attached to the first manifold with bolts and threaded bars. The umbilical or hydraulic flying lead can be connected to the first manifold using clamp connections or multi-quick connections.

In some embodiments, the manifold can include a closed circuit of elements fluidly connected to other elements. The manifold can be manufactured using additive manufacturing.

Another embodiment of the present technology provides for a connection system for subsea distribution units. The connection system can include an umbilical or hydraulic flying lead, a section of tubing made of a unitary material, and a manifold. The umbilical or hydraulic flying lead can be fluidly connected to the unitary section of tubing, and the unitary section of tubing can be fluidly connected to the manifold.

In some embodiments, the unitary section of tubing can be prefabricated or shaped into a required configuration. An adaptor can be used to connect the umbilical or hydraulic flying lead with the unitary section of tubing. The adaptor can have a changing diameter from that of the umbilical or hydraulic flying lead to the diameter of the tubing.

In other embodiments, a flanged connection or fitting can be used to connect the unitary section of tubing to the manifold. The flanged connection or fitting can allow the unitary section of tubing to connect to multiple locations on the manifold. In alternative embodiments, the umbilical or hydraulic flying lead can further include control wiring, power wiring, communications wiring, or hydraulic conduits.

### BRIEF DESCRIPTION OF THE DRAWINGS

The present technology will be better understood on reading the following detailed description of non-limiting embodiments thereof, and on examining the accompanying drawings, in which:

FIG. 1 is a schematic view of a tubing network illustrating a connection between an umbilical or hydraulic flying lead and a manifold on a subsea distribution unit.

FIG. 2 is a cross-section of a manifold with different types of connections.

FIG. 3 is a side schematic view of a stack of two manifolds in a subsea distribution unit.

FIG. 4A is a 3-dimensional perspective view of one embodiment of a manifold according to the present technology.

FIG. 4B is a cutaway for the 3-dimensional perspective view of FIG. 4A along plane 402 showing one embodiment of a manifold according to the present technology.

FIG. 5A is a 3-dimensional perspective view of another embodiment of a manifold according to the present technology.

FIG. 5B is a cutaway for the 3-dimensional perspective view of FIG. 5A along plane 502 showing an embodiment of a manifold according to the present technology.

FIG. 6 is a 3-dimensional perspective view of one embodiment of a manifold with associated tubing systems and connectors according to the present technology.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The invention, however, is not intended to be limited to the specific terms used, and it is to be understood that each specific term can include equivalents that operate in a similar manner to accomplish a similar purpose.

The present technology provides for SDUs with different types of connections, tubing with reduced welding requirements, and manifolds made with additive manufacturing. This can be used to form an SDU that minimizes welding requirements when compared to traditional SDUs, which can result in lower lead times and lower costs to manufacture. The use of additive manufacturing can further allow for the formation of a manifold with reduced numbers of flanges and fittings in the system. This can result in increased reliability of the SDU by reducing the number of potential failure and leak points in the manifold.

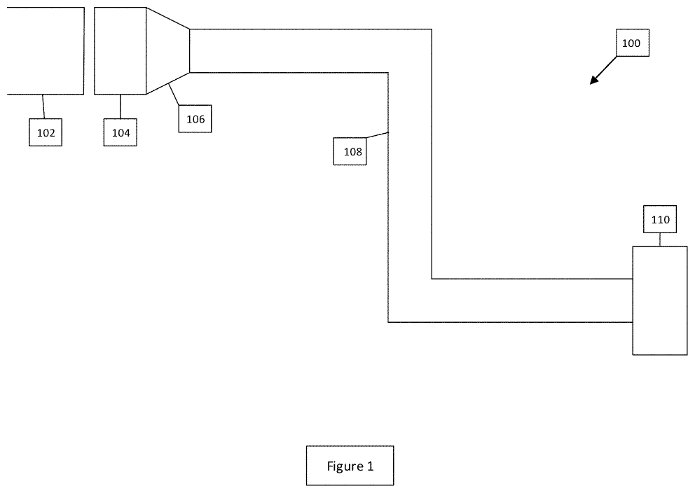

FIG. 1 is a part of tubing network 100 for connecting a subsea line to a manifold according to an embodiment of the present technology. Umbilical or hydraulic flying lead (“HFL”) 102 runs between surface platforms or floating production units to the tubing network 100. The umbilical or HFL 102 can contain, e.g., wiring for control, power, or communications. The umbilical or HFL 102 can also include hydraulic conduits for production fluid, chemical injection, etc.

Attached to umbilical or HFL 102 there can also be an end 104 that attaches the umbilical or HFL 102 to the tubing network 100. The end 104 can further be welded to an adaptor 106. The adaptor 106 can connect the end 104 of the umbilical or HFL 102 to the tubing 108. Since the tubing 108 can be a different size than the umbilical or HFL 102, the adaptor 106 can be used to change from the diameter of the umbilical or HFL 102 to the diameter of the tubing 108.

The tubing 108 can then run from the adaptor 106 to the manifold 110. The tubing 108 can be connected to the manifold 110 through the use of, e.g., a flanged connection or a specific type of fitting. This allows the tubing 108 to connect to different locations on the manifold 110 depending on what the umbilical or HFL 102 is being used for and the demands of the field equipment.

To get from the umbilical or HFL 102 to the manifold 110, the tubing 108 may require different shapes and configurations. Traditionally, discrete sections of tubing 108 are welded into the shape and configuration demanded in the field. This is done by welding individual pieces of tubing together to create the desired shape and configuration. This welding creates additional costs and lead time as discussed above. The more complex the structure of the tubing 108, the greater the number of welds that may be required.

In the present disclosure, the tubing 108 can alternatively be formed using a unitary piece of tubing which is prefabricated or shaped into the required configuration instead of welding multiple different pieces of tubing together. This can result where the tubing 108 can be made of a unitary material instead of multiple different materials welded together. As a result, the number of welds in the system can be reduced to welds between the end 104 and the adaptor 106, and between the adaptor 106 and the tubing 108. There can be no tubing-to-tubing welds required, thereby resulting in a reduced cost in manufacturing the tubing networks 100 used in the SDU.

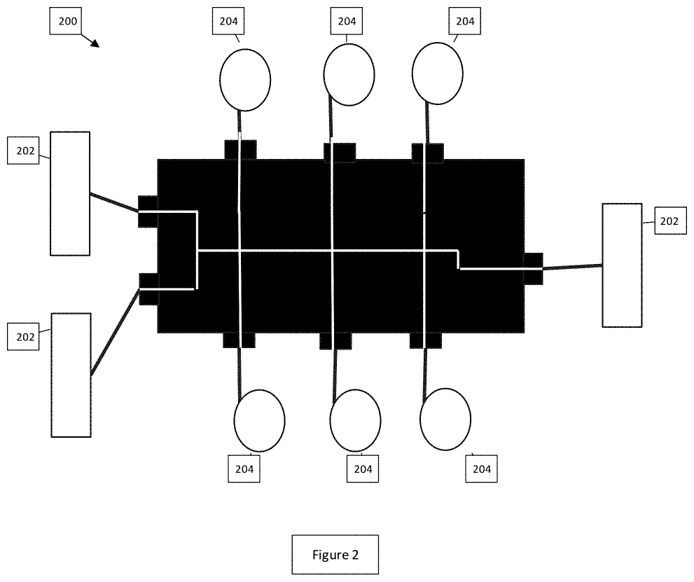

Referring now to FIG. 2, there is shown an embodiment of a manifold 200 according to the present technology. The manifold can be made with additive manufacturing to develop the required structure. The use of additive manufacturing can allow for the formation of a specially shaped manifold that further reduces the number of flanges and fittings within the manifold. Reducing the number of flanges and fittings can reduce the number of leak and/or failure points in the system and can result in increased reliability of the SDU.

The manifold 200 can be made from a unitary material such that every element of the manifold 200 is made from the same material. This can be done through the use of additive manufacturing to develop the manifold in a single process. This can be in contrast to traditional manifolds comprising multiple elements welded together to form the manifold.

In the example embodiment shown, there can be two types of connections to the manifold. Clamp connections 202 can be used for larger connections such as jumpers, spools, and umbilical terminations. Multi-quick connections (“MQCs”) 204 can be used for other elements attached to the distribution system. The manifold itself can provide numerous pathways to and from each of the different elements in the manifold.

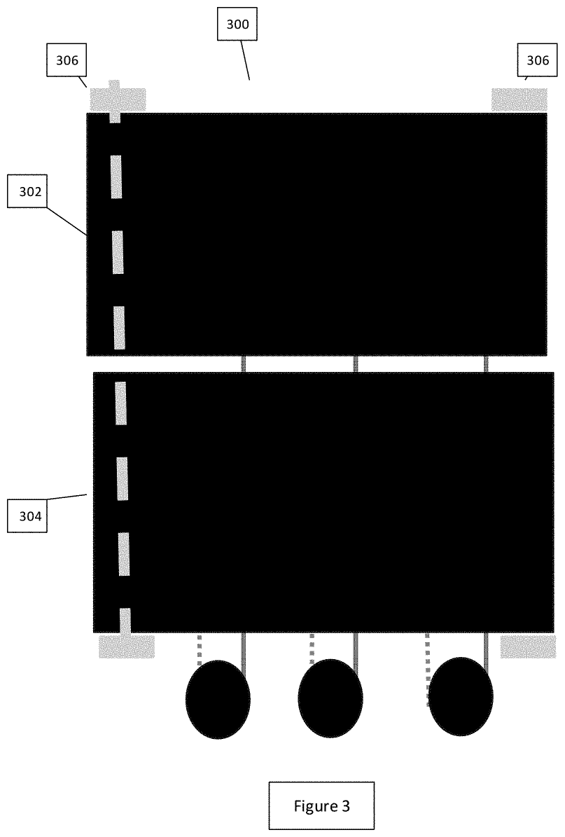

FIG. 3 shows how multiple manifolds can be combined together according to the present technology. FIG. 3 shows a first manifold 302 and a second manifold 304. The first manifold 302 can be, for example, an eight-way chemical block. The second manifold 304 can be, for example, a four-way hydraulic block. The two manifolds can be connected with bolts and threaded bars 306 to form a more complex manifold 300. It is to be understood that any appropriate number of manifolds can be combined, and such manifolds can be of any type.

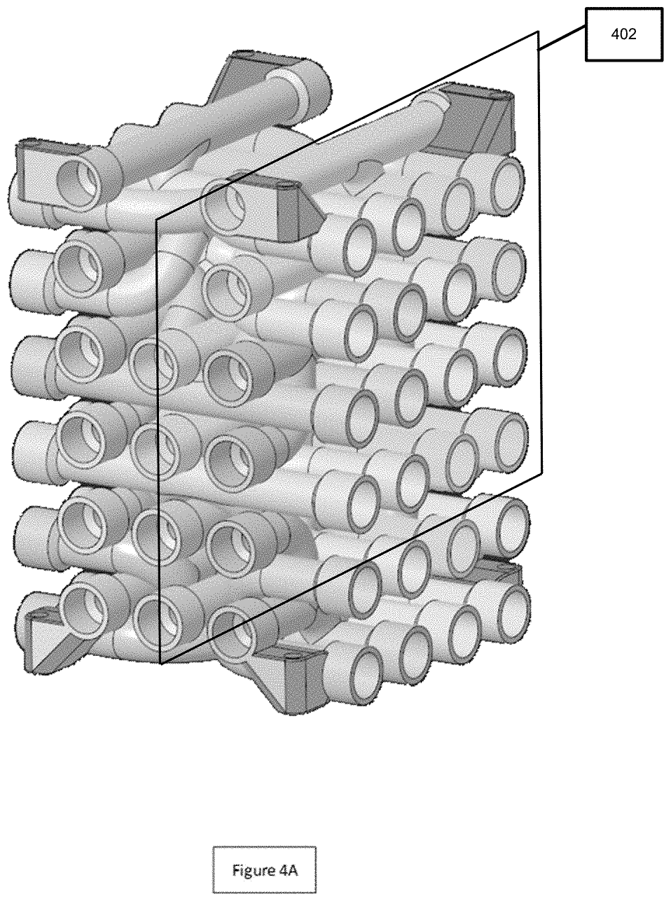

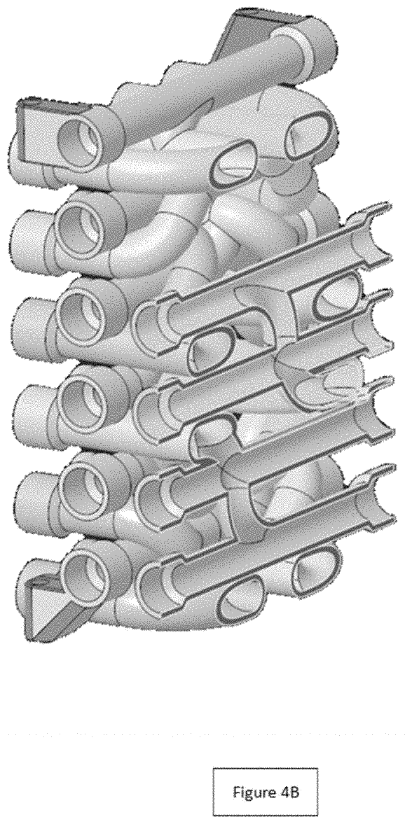

FIG. 4A is a first embodiment of a manifold for a subsea distribution system. The present manifold can provide connections for 80 chemical lines in eight separate closed circuits. The manifold can be constructed using additive manufacturing. This can first reduce the number of welds within the manifold itself. This can also result in a more compact manifold as access for welding is not required.

Each closed circuit of the manifold can include both clamp connections and MQCs for various operations. In an embodiment, the clamp connections can be used in connections to the umbilicals or HFLs while the MQCs can be used in connections to piping trees. There can be more MQCs than clamp connections for each individual manifold.

FIG. 4B is a cutaway of the manifold of FIG. 4A along the plane 402. FIG. 4B provides a view of the internal aspects of the manifold and how the additive manufacturing process can allow for the connecting tubing to be fit into a smaller space than traditional manifolds.

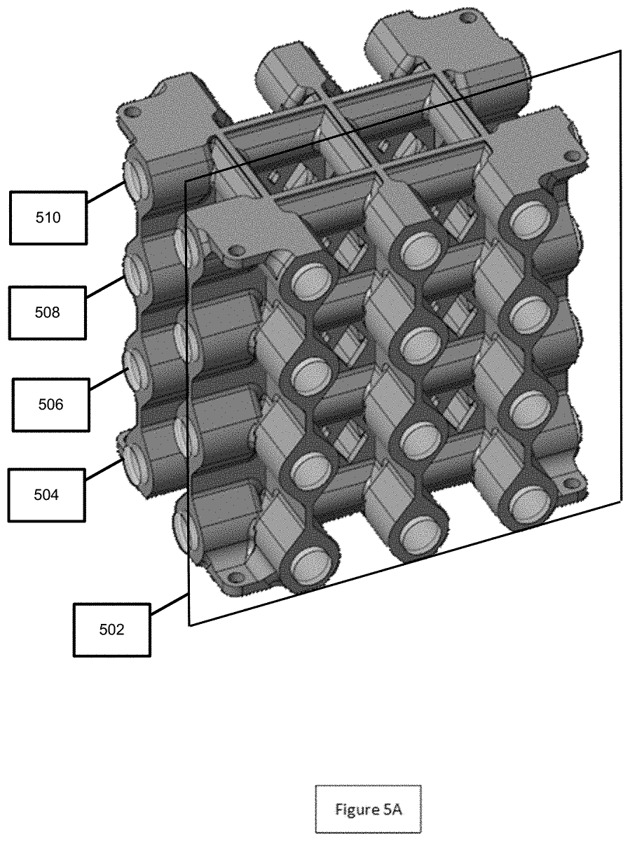

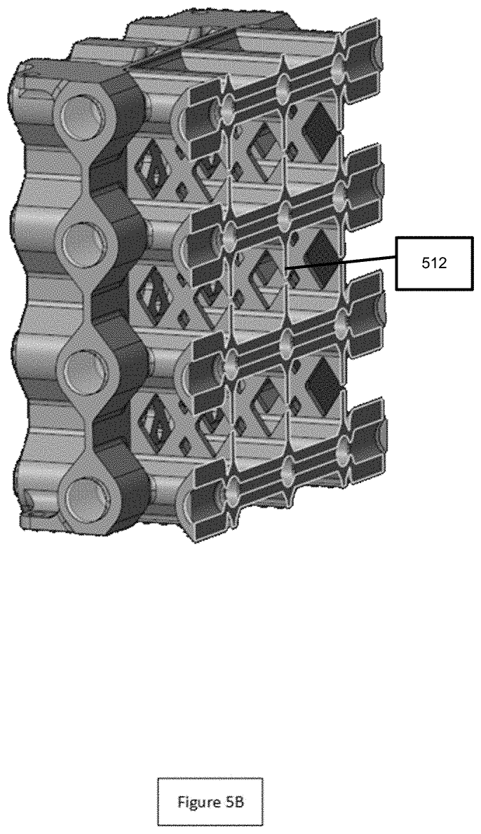

FIG. 5A is a second embodiment of a manifold for a subsea distribution system. This embodiment of the present manifold can provide connections for 40 chemical lines in four separate closed circuits. The present manifold can provide for layered closed circuits with each circuit built on top of the previous one through additive manufacturing. Circuits 504, 506, 508, and 510 can be used as closed systems for different chemicals and fluids according to the demands of the current operations. The manifold can also be expanded by printing additional layers of closed systems above circuit 510.

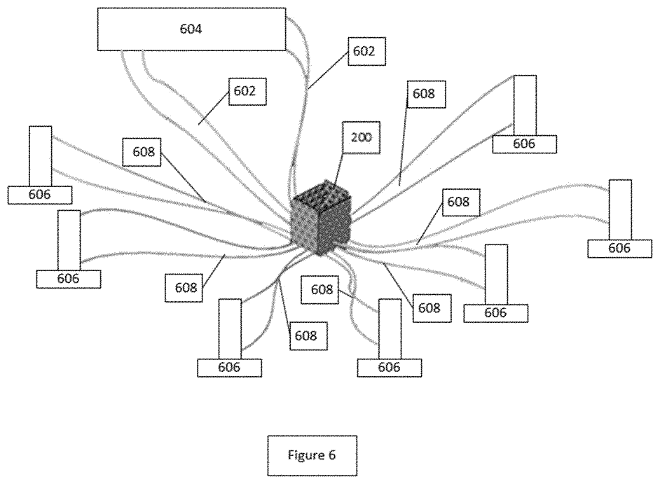

FIG. 5B is a cutaway of the manifold of FIG. 5A along the plane 502. FIG. 5B further provides additional illustration of supporting structure 512. The supporting structure 512 can be made with additive manufacturing and can be integral with the circuits 504, 506, 508, and 510. FIG. 6 is an embodiment of the manifold 200 being used as a part of a subsea distribution unit according to the present technology. Umbilicals or HFLs 602 can be attached to the SDU using clamp connections, MQCs, or any other appropriate type of connection. The umbilicals or HFLs 602 can run from the manifold 200 to the surface platforms or floating production units 604. These umbilicals or HFLs 602 can be used to transport fluids from the surface platforms or floating production units 604 to the manifold 200 for distribution to the piping trees 606. These umbilicals or HFLs 602 can be used to transport hydrocarbons produced by the wells associated with the piping trees 606 back to the surface platforms or floating production units 604.

FIG. 6 also provides a number of connections 608 from the manifold 200 to the piping trees 606. These connections 608 can provide fluid flow to and from the individual piping trees 606 from the manifold 200. Such an arrangement can allow for chemicals or fluids to be transported to and from multiple piping trees 606 simultaneously without the requirement of multiple umbilicals or HFLs 602 for each chemical or fluid type running from the surface platforms or floating production units 604.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A subsea distribution system comprising:
a first manifold comprising a unitary material;
a plurality of element connection points on the first manifold; and
a plurality of manifold connection points on the first manifold.

2. The system of claim 1 wherein the plurality of element connection points comprises clamp connections.

3. The system of claim 2 wherein the plurality of element connection points comprises multi-quick connections.

4. The system of claim 2 further comprising:
at least one additional manifold connected to the first manifold.

5. The system of claim 3 wherein the first manifold is connected to the at least one additional manifold using bolts with threaded bars.

6. The system of claim 2 wherein the first manifold is manufactured with additive manufacturing.

7. An offshore recovery system comprising:
a surface platform or floating production unit;
at least one umbilical or hydraulic flying lead connected to the surface platform or floating production unit;
a first manifold comprising a unitary material, connected to the at least one umbilical or hydraulic flying lead; and
at least one piping tree connected to the first manifold.

8. The system of claim 7 wherein the at least one umbilical or hydraulic flying lead is connected to the at least one manifold by a section of unitary tubing.

9. The system of claim 7 wherein the unitary section of tubing is prefabricated or shaped into a required configuration.

10. The system of claim 7 further comprising:
at least one additional manifold connected to the first manifold using bolts with threaded bars.

11. The system of claim 7 wherein the at least one umbilical or hydraulic flying lead is connected to the first manifold using clamp connections or multi-quick connections.

12. The system of claim 7 wherein the manifold comprises at least one closed circuit of elements fluidly attached to other elements on the closed circuit.

13. The system of claim 7 wherein the first manifold is manufactured with additive manufacturing.

14. A subsea distribution connection system comprising:
an umbilical or hydraulic flying lead;
a section of tubing comprising a unitary material, fluidly connected to the umbilical or hydraulic flying lead; and
a manifold fluidly connected to the unitary section of tubing.

15. The system of claim 14 wherein the unitary section of tubing is prefabricated or shaped into a required configuration.

16. The system of claim 14 further comprising:
an adaptor fluidly connecting the umbilical or hydraulic flying lead with the unitary section of tubing.

17. The system of claim 16 wherein the adaptor changes from a diameter of the umbilical or hydraulic flying lead to a diameter of the seamless section of tubing.

18. The system of claim 14 further comprising:
a flanged connection or fitting fluidly connecting the seamless section of tubing with the manifold.

19. The system of claim 18 wherein the flanged connection or fitting connects to multiple locations on the manifold.

20. The system of claim 14 wherein the umbilical or hydraulic flying lead further comprises control wiring, power wiring, communications wiring, or hydraulic conduits.
